(19) United States
(12) Patent Application Publication
(10) Pub. No.: US 2018/0055716 A1
(43) Pub. Date: Mar. 1, 2018

(54) TWS Product With Photoluminescent Feature

(71) Applicant: ADA Solutions, Inc., Wilmington, MA (US)

(72) Inventor: John P. Flaherty, Woburn, MA (US)

(21) Appl. No.: 15/690,841

(22) Filed: Aug. 30, 2017

Related U.S. Application Data
(60) Provisional application No. 62/381,318, filed on Aug. 30, 2016.

(51) Int. Cl. A61H 3/06; E01C 11/22

(52) U.S. Cl. CPC A61H 3/066; A61H 2003/063; A61H 3/061; E01C 11/222

(57) ABSTRACT

The problems of the prior art are addressed by a novel tactile warning system that utilizes a separate component to add photoluminescence to the tile. In certain embodiments, the tactile warning system is a replaceable tile and a cap used to cover the fastener is made using a photoluminescent material. In other embodiments, the tactile warning system is a surface applied tile, a Cast-In-Place tile or a replaceable tile, and cavities are created on the upper surface of the tile. A photoluminescent insert is then disposed in these cavities. The photoluminescent insert may be made of plastic, aluminum or acrylic.

This application claimed priority of U.S. Provisional Patent Application Ser. No. 62/381,318, filed Aug. 30, 2016, the disclosure of which is incorporated by reference in its entirety.

### BACKGROUND OF THE INVENTION

Tactile Warning Surface (TWS) products are required in certain locations under the Americans with Disabilities Act Accessibility Guidelines (ADAAG). The ADAAG defines certain types of applications, including curb ramps/pedestrian crossings, commercial applications, such as retailers, hotels and restaurants, and transit facilities. TWS products are utilized to detect hazardous drop-offs, including platform edges and loading docks, and hazardous vehicular areas, such as curb ramps on street corners and intersections, uncurbed transitions between pedestrian and vehicular areas such as at the front of retail establishments.

Visually impaired and fully sighted persons may rely on a combination of visual cues (color contrast), tactile cues (sweeping cane, sole of shoe, through wheelchair wheels, walker wheels), and audio cues (sound attenuation, which can be achieved by use of dissimilar materials such as composite TWS and concrete substrate) when electing to use TWS products as a means of edge and hazardous vehicular area detection.

TWS products define a series of spaced raised truncated domes. In some embodiments, these products are installed in curb ramps, pedestrian ways and commercial areas by setting into the fresh concrete a plastic, composite or metal TWS product that defines on its upper surface the series of spaced raised truncated domes required by the ADAAG. These Cast-In-Place (CIP) TWS products typically have a perimeter flange that extends downward into the concrete. The perimeter flange has one or more holes therein. When installed in wet concrete, concrete flows through the holes in the perimeter flange securing the CIP TWS product in place.

Some CIP TWS Units are set into fresh concrete with fasteners that pass through holes located in the domes. There are also CIP TWS Units in which the head of the fastener is shaped like a dome, in which case the fastener is located in place of one of the domes.

Another solution is a surface applied (SA) TWS panel that is applied to a finished substrate. A SA TWS panel is typically mechanically fastened (e.g., with a nylon sleeve anchor with a stainless steel pin) and adhered using an adhesive to the underlying substrate, and then caulked around the perimeter to compensate for substrate irregularities, minimize water intrusion, and provide a superior architectural finish.

Additionally, another solution is a replaceable TWS panel. A replaceable TWS panel has anchors removably affixed to the bottom surface, using fasteners. The assembled tile is installed in wet concrete and allowed to set. To replace the tile, the fasteners are removed and the tile is pried off the concrete, leaving the anchors in place. Another tile is simply placed where the previous tile was located and fasteners are again used to secure the tile to the anchors.

There has been an interest in including a photoluminescent feature to these TWS products. For example, in a subway system, it may be desirable to have the TWS product, or at least a portion thereof, glow if there is a power failure. This allows the visually impaired to make their way to an exit and to avoid falling off the platform.

Currently, this photoluminescent feature is incorporated in the TWS product using a strip of material. A trough or channel may be created in the underlying TWS product, and the photoluminescent strip is typically glued into this trough. This photoluminescent strip captures energy, in the form of light, during daylight hours, or from artificial light, and emits this energy in the form of light in the absence of ambient light.

However, these photoluminescent strips may be problematic. First, the photoluminescent strips are typically thin and structurally weak, and are held in place by an adhesive. External devices, such as plow blades, brooms, and other cleaning equipment, may tend to pull the photoluminescent strip from the trough. For example, an end of the photoluminescent strip may be lifted from the channel by cleaning equipment. Once lifted, the photoluminescent strip may rip off. To overcome this issue, the photoluminescent strip may have a thin metal backing to add strength. However, if an end of this photoluminescent strip is lifted, the metal backing may become a tripping hazard.

Therefore, it would be beneficial if there was a TWS product that incorporated the photoluminescent feature without the issues associated with the current solutions.

### SUMMARY

The problems of the prior art are addressed by a novel tactile warning system that utilizes a separate component to add photoluminescence to the tile. In certain embodiments, the tactile warning system is a replaceable tile and a cap used to cover the fastener is made using a photoluminescent material. In other embodiments, the tactile warning system is a surface applied tile, a Cast-In-Place tile or a replaceable tile, and cavities are created on the upper surface of the tile. A photoluminescent insert is then disposed in these cavities. The photoluminescent insert may be made of plastic, aluminum or acrylic.

### BRIEF DESCRIPTION OF THE DRAWINGS

For a better understanding of the present disclosure, reference is made to the accompanying drawings, which are incorporated herein by reference and in which:

FIG. 1A is a top view of a TWS product having a photoluminescent feature according to one embodiment;

FIG. 1B shows a side view of the TWS product of FIG. 1A;

FIG. 1C shows a cross-sectional view of the TWS product of FIG. 1A taken along line A-A;

FIG. 1D shows an enlarged view of a portion of the cross-sectional view of FIG. 1C;

FIG. 2A is a top view of a TWS product having a photoluminescent feature according to a second embodiment;

FIG. 2B shows a side view of the TWS product of FIG. 2A;

FIG. 2C shows a cross-sectional view of the TWS product of FIG. 2A taken along line B-B;

FIG. 2D shows a fastener used to secure the TWS product of FIG. 2A to the underlying substrate;

FIG. 3 is a top view of a TWS product having a photoluminescent feature according to a third embodiment;

FIG. 4A is a top view of a TWS product having a photoluminescent feature according to a fourth embodiment;

FIG. 4B shows a cross-sectional view of the TWS product of FIG. 4A taken along line B-B; and

FIG. 5 is a top view of a TWS product having a photoluminescent feature according to a fifth embodiment.

### DETAILED DESCRIPTION OF THE INVENTION

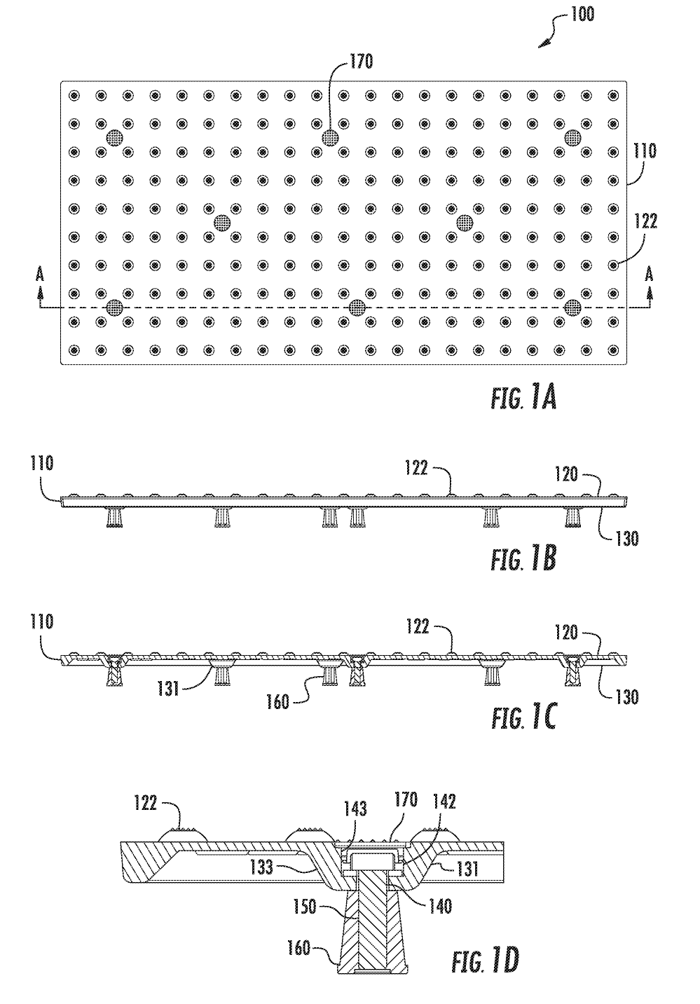

A first embodiment of the TWS product comprises a fiberglass reinforced resin composite wet set replaceable TWS unit 100, shown in FIGS. 1A-1D. FIG. 1A shows a top view of the replaceable TWS unit 100. FIG. 1B shows a side view, while FIG. 1C shows a cross-sectional view taken through line A-A. FIG. 1D shows an enlarged view of FIG. 1C, showing one of the holes in the replaceable TWS unit 100.

TWS unit 100 may be a unitary, essentially homogeneous fiberglass-reinforced composite body 110 that includes an upper surface 120 and a lower surface 130. A plurality of protruding, truncated domes 122 and/or other shapes such as oblong bars or other desirable projection shapes may be disposed on the upper surface 120. In one embodiment, the size, shape and spacing of the projections on the upper surface 120 meets the present requirements for the ADAAG. Holes 140 pass through the thickness of body 110. These holes 140 may be created by molding into the body 110 a recess 142 in upper surface 120, and an aligned, downwardly-protruding lower projection 131 in lower surface 130. Lower projection 131 preferably has a tapered, generally truncated conical shape defining tapered sides 133. Lower projections 131 may define a taper angle of about 120 degrees, although such is not a limitation. In other embodiments, the lower surface 130 may not have any lower projections 131. Rather, the lower surface 130 may be flat. In certain embodiments, the holes 140 may be positioned near the four corners of the replaceable TWS unit 100. Additionally or alternatively, additional holes 140 may be disposed near the interior of the TWS unit 100. FIG. 1A shows eight such holes 140, where four holes 140 are positioned near the respective corners of the replaceable TWS unit 100. Two additional holes 140 are positioned along horizontal lines connecting the corner holes. Two additional holes 140 are disposed along a center line of the TWS unit 100, offset from the other holes 140 in a direction perpendicular to the horizontal direction. While FIG. 1A shows this specific arrangement of the holes 140, it is noted that other configurations are also possible and the disclosure is not limited to this arrangement. Further, the number of holes 140 is not limited by this disclosure.

A fastener 150, such as a bolt, is passed from the upper surface 120 through a hole 140. The fastener 150 attaches to an anchor 160, which may be internally threaded to accept the fastener 150. The fasteners 150 serve to secure the anchors 160 against the lower surface 130 of the body 110. The fasteners 150 are disposed within the recesses 142 at a height below the upper surface 120 and therefore do not affect the level of the upper surface 120. The holes 140 are then covered by caps 170. These caps 170 serve to cover the heads of the fasteners 150 and align with the rest of the upper surface 120. Caps 170 also inhibit the collection of dirt and other debris around the head of the fastener 150, to facilitate its removal. Cap 170 preferably provides a watertight seal to the body 110 of the TWS unit 100 as well, to inhibit water infiltration which can lead to corrosion of the fasteners 150, thus weakening of the coupling of the replaceable TWS unit 100 to the underlying substrate.

These caps 170 may be held in place via a friction fit. As best seen in FIG. 1D, near the upper surface 120, each hole 140 may define a ledge 143. This ledge 143 may have a diameter slightly larger than the hole 140. The ledge 143 may also have a depth that is approximately equal to, or slightly greater than, the thickness of the cap 170. The cap 170 has a diameter substantially identical to that of the ledge 143. Thus, when installed, the cap 170 sits on the ledge 173, maintaining a continuous flat surface on the upper surface 120. Further, the cap 170 may include a small notch or irregularity along its circumference to allow a screwdriver blade or other similar tool to pry the cap 170 off the ledge 143.

In certain embodiments, the upper surface 120 is also covered with dimples, which may be less than 0.050 inches tall, and may be cone-shaped. Additionally, the cap 170 may also be covered with dimples to match the rest of the upper surface 120.

In one non-limiting example of the replaceable TWS unit, some of the key dimensions are as follows: domes 122 may be about 0.9 inches wide at the base and 0.45 inches at the top, with a height of 0.2 inches, and center-to-center spacing of about 2.35 inches. In certain embodiments, the spacing may range from 1.6 inches to 2.4 inches; the wider spacing provides more room for unobstructed passing of wheeled devices such as walkers and shopping carts. Body 110 may be about 0.312 inches thick. Cap 170 has a diameter of about 1.375 inches and a thickness of about 1 mm.

In this embodiment, the photoluminescence feature is incorporated into the caps 170. Each cap 170 is constructed using a fluorescent or phosphorescent material.

The photoluminescent cap may be fabricated by introducing a photoluminescent pigment into the plastic used to create the cap 170 in the molding process. For example, in some embodiments, the photoluminescent pigment may be zinc sulfide, strontium silicate, strontium aluminate or other alkaline earth aluminates. Of course, other photoluminescent materials may also be used and the disclosure is not limited to these illustrative examples.

Thus, in this embodiment, the cap 170 is a plastic component which is photoluminescent. In certain embodiments, the caps 170 are the only part of the TWS unit 100 that is photoluminescent. In other words, the body 110 is not made from a photoluminescent material.

In certain embodiments, the caps 170 are formed using injection molding, although other processes may also be used. In the case of injection molding, the photoluminescent pigment may be added to a resin, such as a polyethylene base resin. In certain embodiments, the photoluminescent pigment and the resin are mixed in equal amounts. In other embodiments, the percentage of resin in the mixture may be greater than 50%. The amount of photoluminescent pigment used may determine the luminance of the photoluminescent cap. In some embodiments, the luminescence may be greater than 300 grade. In certain embodiments, the luminescence may be about 500 grade. This mixture is then stirred, heated and injected into a mold. The mold has the size and shape of one or more of the desired final products. When cooled, the plastic is removed from the mold and forms the caps 170. In certain embodiments, the caps 170 are fabricated with dimples on the top surface to match the upper surface 120.

In this embodiment, the photoluminescent feature of the TWS unit 100 may also be replaceable. For example, using a screwdriver or other implement, the cap 170 can be pried off the ledge 143. A new cap 170 may then be installed on the ledge 143.

The caps 170 described above advantageously may also be introduced to existing installed replaceable TWS units, which employ a traditional cap. In this case, the traditional cap, which is typically plastic, is removed using a screwdriver or other implement. A new, photoluminescent cap 170 can then be installed in the existing installed replaceable TWS unit, effectively converting the traditional TWS unit into one having a photoluminescent feature at little cost and effort. Furthermore, since the cap 170 is held in place using a friction fit, the risk of accidental removal is low.

It is noted that the above disclosure described indicates that the caps 170 are held in place using a friction fit without the use of adhesive. However, in other embodiments, an adhesive may be used to hold the cap 170 in place if desired.

To maximize the resilience and lifetime of the caps 170, in certain embodiments, the top surface of the caps 170, when installed, is at or below the level of the upper surface 120.

While FIG. 1A shows eight caps 170, the disclosure is not limited to any particular number. More or fewer caps 170 may be used. Further, not all of the caps 170 need to be photoluminescent. For example, in one particular embodiment, only the caps 170 along the lower row are photoluminescent, while the remaining caps are made of traditional materials.

The concept of using a separate component made of photoluminescent material may also be applied to other types of TWS units as well. For example, surface applied (SA) TWS units may be modified to utilize photoluminescent inserts.

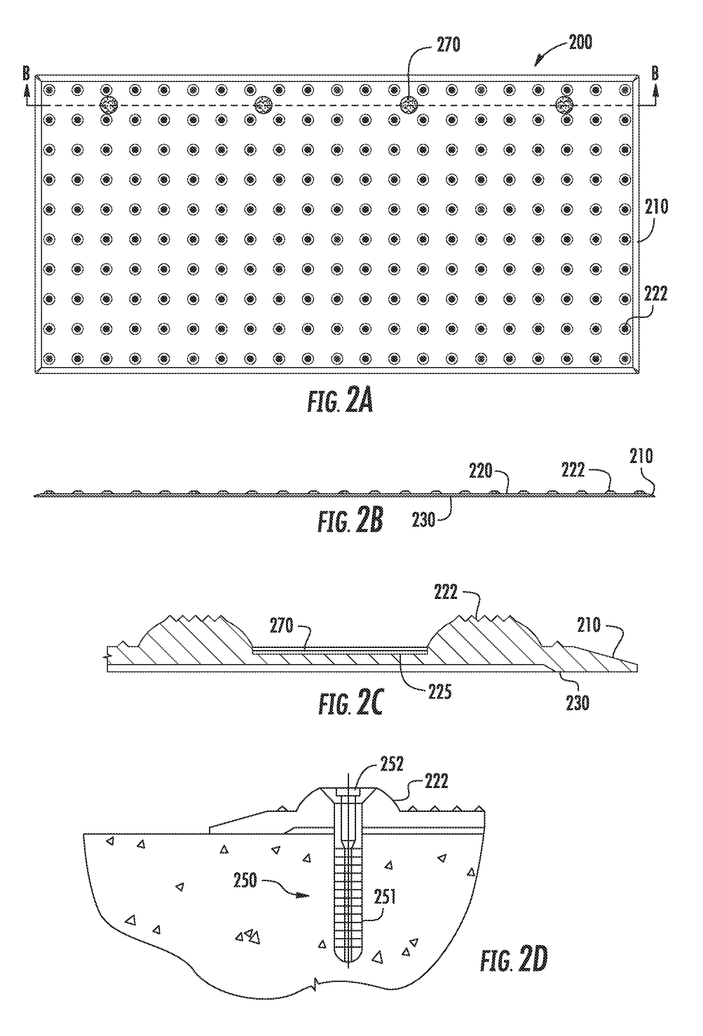

FIGS. 2A-2D shows a surface applied (SA) TWS unit 200 that utilizes a photoluminescent feature. FIG. 2A shows a top view of the SA TWS unit 200, while FIG. 2B shows a side view. FIG. 2C shows an enlarged view of a portion of the cross-section of FIG. 2A along line B-B. FIG. 2D shows the fastener used to secure the SA TWS unit 200 to the substrate.

As described above, SA TWS units 200 are installed on top of existing substrates, typically using an adhesive. In certain embodiments, fasteners 250 are installed through the SA TWS unit 200 and into the substrate to better secure the unit. As shown in FIG. 2B, the SA TWS unit 200 has a body 210 having an upper surface 220 and a lower surface 230. A plurality of protruding, truncated domes 222 and/or other shapes such as oblong bars or other desirable projection shapes may be disposed on the upper surface 220. In one embodiment, the size, shape and spacing of the projections on the upper surface 220 meets the present requirements for the ADAAG. A plurality of dimples may also be disposed on the upper surface 220. In certain embodiments, the edges of the SA TWS unit 200 may be sloped to present a gradual transition from the underlying substrate to the SA TWS unit 200, as shown in FIG. 2C.

One or more domes 222 may accommodate a fastener 250, which passes through a hole in the center of the dome 222 and enters the underlying substrate, as best shown in FIG. 2D. The fastener 250 may comprise a sleeve anchor 251 with a nail 252. To install a SA TWS unit 200, holes may be pre-drilled in the underlying substrate. After the holes are drilled in the substrate, the SA TWS unit 200 is disposed on the substrate, and the sleeve anchors 251 are pushed through the domes 222 and into the pre-drilled holes. Nails 252 are then pressed into the sleeve anchors 251, forcing the sleeve anchors 251 to expand in the width direction, thereby securing them to the substrate. In certain embodiments, an adhesive is applied to the lower surface 230 of the SA TWS unit 200 prior to it being disposed in the substrate. In other embodiments, the adhesive is applied to the substrate prior to disposing the SA TWS unit 200 on the substrate.

Returning to FIGS. 2A-2D, the lower surface 230 of the SA TWS unit 200 is substantially flat, so as to sit on the underlying substrate. The body 210 of the SA TWS unit 200 may be about 0.135 inches thick. This thickness is preferably minimal, since the SA TWS unit 200 rests on top of the underlying substrate. A thicker SA TWS unit would create a more abrupt transition between the substrate and the SA TWS unit 200.

As best seen in FIG. 2C, a small cavity 225 is formed in the upper surface 220 of the SA TWS unit 200. In certain embodiments, the cavity 225 may be circular, although other shapes are also possible. The cavity 225 may have a depth less than the thickness of the body 210. This cavity 225 may penetrate the body 210 a depth of about 0.055 inches, although other depths are also possible and within the scope of the disclosure. The cavity 225 may also have a diameter of about 1.375 inches, although other diameters are also possible. An insert 270 may then be placed in this cavity 225. The insert 270 may have a thickness that is less than or equal to the depth of the cavity 225. In certain embodiments, the insert 270 may have a thickness of about 0.032 inches thick, although other thicknesses are also possible. However, in most embodiments, the thickness of the insert 270 is less than the thickness of the body 210, so that a cavity 225 may be created in the body 210. The insert 270 may also have a diameter of about 1.375 inches. In certain embodiments, the inserts 270 are pressed into the cavities 225 using a friction fit. In other embodiments, an adhesive may be disposed between the insert 270 and the body 210 to further secure the insert 270 to the body 210. The inserts 270 may have a small notch or irregularity along its circumference to allow a screwdriver blade or other similar tool to pry the insert 270 off the cavity 225.

The cavities 225 in the body 210 may be created by adding an insert in the mold for the body 210. This mold insert is disposed in the location where the cavity 225 is to be created. In this way, the body 210, as molded, has the cavities 225. However, in other embodiments, the cavity 225 may be created after the body 210 is created, such as by removing material from the upper surface 220 of the body 210.

The inserts 270 are photoluminescent and may be fabricated by introducing a photoluminescent pigment into the plastic used to create the insert 270 in the molding process. For example, in some embodiments, the photoluminescent pigment may be zinc sulfide, strontium silicate, strontium aluminate or other alkaline earth aluminates. Of course, other photoluminescent materials may also be used and the disclosure is not limited to these illustrative examples.

Thus, in this embodiment, the insert 270 is a plastic component which is photoluminescent. In certain embodiments, the inserts 270 are the only part of the SA TWS unit 200 that is photoluminescent. In other words, the body 210 is not made from a photoluminescent material.

In certain embodiments, the inserts 270 are formed using injection molding, although other processes may also be used. In the case of injection molding, the photoluminescent pigment may be added to a resin, such as a polyethylene base resin. In certain embodiments, the photoluminescent pigment and the resin are mixed in equal amounts. In other embodiments, the percentage of resin in the mixture may be greater than 50%. This mixture is then heated and injected into a mold. The mold has the size and shape of the desired final product. When cooled, the plastic is removed and forms the inserts 270. In certain embodiments, the inserts 270 are fabricated with dimples on the top surface to match the upper surface 220.

In other embodiments, the inserts 270 may be made from a metal substrate. For example, thin discs may be punched or otherwise created from aluminum or another metal. In one particular embodiment, the discs may have a diameter of about 1.375 inches. At least the front surface of these metal discs may then be covered with a photoluminescent material, such as strontium aluminate or another material. In other embodiments, the photoluminescent material is disposed on both surfaces of the metal disc. This photoluminescent material may be painted onto the metal disc or otherwise applied. In certain embodiments, the photoluminescent material is then coated with a ceramic material. This ceramic coating serves to protect the underlying photoluminescent material from wear and damage. In one particular embodiment, the total thickness of the insert 270 may be about 0.81 mm thick, where the metal disc is about 0.56 mm thick and where the combined thickness of the photoluminescent material and ceramic coating is about 0.25 mm. In one particular embodiment, the cavity 225 may be about 1.4 mm deep. The thickness of the insert 270 allows an adhesive having a thickness of 0.6 mm to be applied between the body 210 and the insert 270 without having the insert 270 protrude past the upper surface 220. In certain embodiments, the photoluminescent material is a 300 grade material. In other embodiments, the photoluminescent material may be more photoluminescent, such as a 500 grade material.

In other embodiments, the inserts 270 may be made from an acrylic substrate. Acrylic discs may be formed. In one particular embodiment, the discs may have a diameter of about 1.375 inches. Then, at least the front surface of these acrylic discs may then be covered with a photoluminescent material, such as strontium aluminate or another material. In other embodiments, the photoluminescent material is disposed on both surfaces of the acrylic disc. This photoluminescent material may be painted onto the acrylic disc or otherwise applied. In certain embodiments, the acrylic disc may then be coated with a ceramic material to protect the photoluminescent material. One benefit of acrylic discs is that they are difficult to remove without breaking, making them less susceptible to theft or vandalism.

While FIG. 2A shows four inserts 270 disposed on the upper surface 220 of the SA TWS unit 200, the disclosure is not limited to this embodiment. Any number of cavities 225 may be created in the SA TWS unit 200 and populated with inserts 270. Further, in certain embodiments, all of the inserts 270 are photoluminescent. In other embodiments, less than all of the inserts 270 are photoluminescent.

As was described with respect to FIGS. 1A-1D, the inserts 270 may disposed along one edge of the SA TWS unit 200. This may be the approach side if the SA TWS units 200 are employed on a raised platform. Thus, if multiple SA TWS units 200 are placed adjacent to one another, a luminescent dotted line may be created.

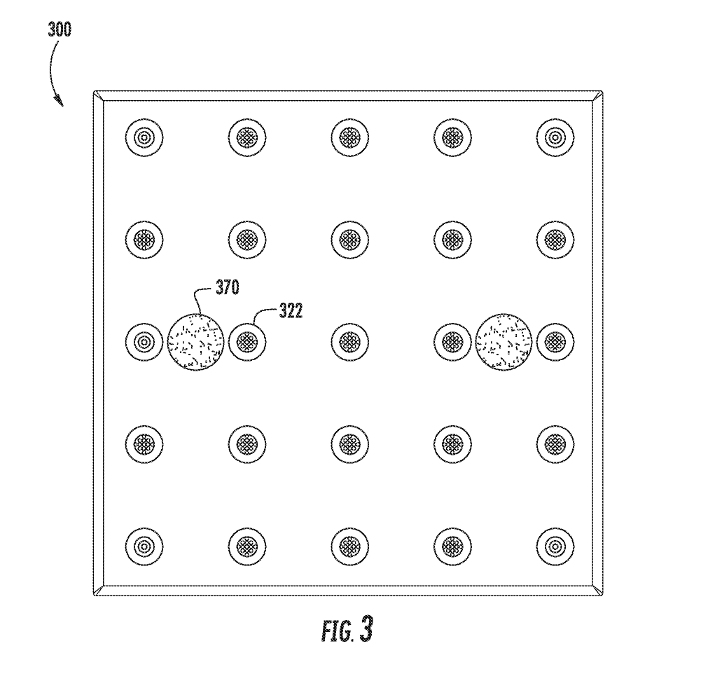

Further, FIGS. 2A-2D show the inserts 270 disposed between two rows of domes 222. Specifically, some of the inserts 270 are located between two adjacent rows of domes 222 in both the horizontal or vertical direction. However, other embodiments are also possible. For example, FIG. 3 shows another embodiment that includes a SA TWS unit 300. In this embodiment, the inserts 370 are disposed between two domes 322, such that the inserts 370 and the domes 322 are all disposed on a single line.

To maximize the resilience and lifetime of the inserts 270, in certain embodiments, the top surface of the inserts 270, when installed, is at or below the level of the upper surface 220.

The same concept of using a cavity and a photoluminescent insert may also be applied to other TWS units, such as cast-in-place (CIP) TWS units.

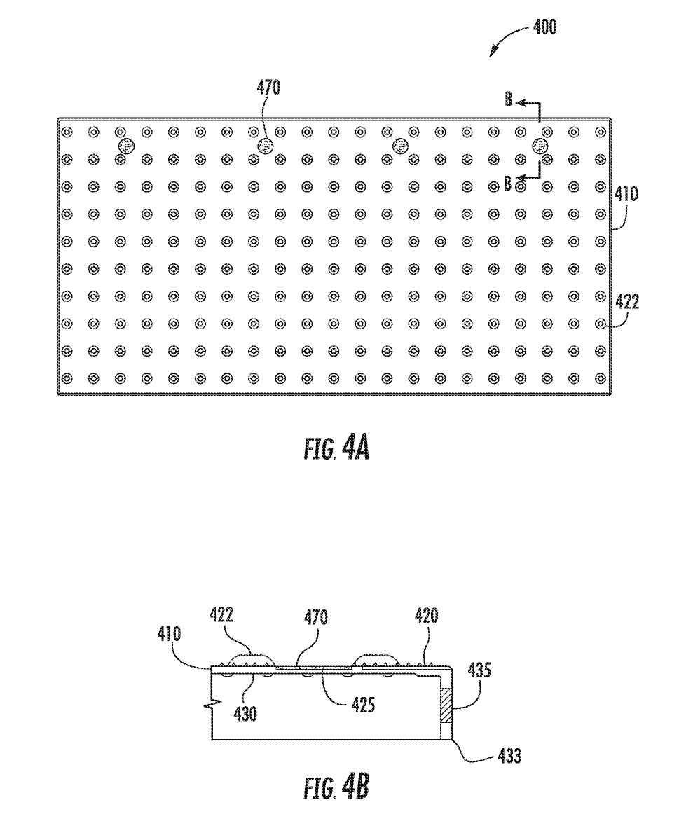

FIGS. 4A-4B shows a Cast-In-Place (CIP) TWS unit 400 that utilizes a photoluminescent feature. FIG. 4A shows a top view of the CIP TWS unit 400. FIG. 4B shows an enlarged view of a portion of the cross-section of FIG. 4A along line B-B.

As described above, CIP TWS units 400 are set into fresh concrete. The perimeter flange has one or more holes therein. As the CIP TWS unit 400 is pressed into the fresh concrete, air and concrete passes through these holes, thereby eliminating air pockets under the CIP TWS unit 400. The concrete then hardens in the hole, serving to anchor the CIP TWS unit 400 in place. In certain embodiments, fasteners (not shown) are installed through the CIP TWS unit 400 and into the substrate to better secure the unit. As shown in FIG. 4B, the CIP TWS unit 400 has a body 410 having an upper surface 420 and a lower surface 430. A plurality of protruding, truncated domes 422 and/or other shapes such as oblong bars or other desirable projection shapes may be disposed on the upper surface 420. In one embodiment, the size, shape and spacing of the projections on the upper surface 420 meets the present requirements for the ADAAG. A plurality of dimples may also be disposed on the upper surface 420. A flange 433 extends downward from the lower surface 430. In certain embodiments, the flange 433 exists along the perimeter of the CIP TWS unit 400. In certain embodiments, the flange 433 may exist on less than all of the sides of the perimeter of the CIP TWS unit 400. In certain embodiments, the flange 433 may also extend downward from locations which are not along the perimeter. The flange 433 may extend downward 1.125 inches from the lower surface 430, although other dimensions may be used. The flange 433 may have one or more holes 435 to allow air and concrete to pass through. In certain embodiments, the holes 435 may have a diameter of 0.625 inches, although other dimensions are within the scope of the disclosure.

To install a CIP TWS unit 400, the unit is pressed into fresh concrete. Air exits from under the CIP TWS unit 400 through the holes 435, eliminating air packets and improving the integrity of the assembled unit. As the concrete dries, the concrete that fills the holes 435 serves to help secure the CIP TWS unit 400 to the substrate.

Returning to FIGS. 4A-4B, the lower surface 430 of the CIP TWS unit 400 is substantially flat with a downward extending flange 433. The body 410 of the CIP TWS unit 400 may be about 0.25 inches thick, although other dimensions may be used.

As best seen in FIG. 4B, a small cavity 425 is formed in the upper surface 420 of the CIP TWS unit 400. In certain embodiments, the cavity 425 may be circular, although other shapes are also possible. The cavity 425 may have a depth less than the thickness of the body 410. This cavity 425 may penetrate the body 410 a depth of about 0.055 inches, although other depths are also possible and within the scope of the disclosure. The cavity 425 may also have a diameter of about 1.375 inches, although other diameters are also possible. An insert 470 may then be placed in this cavity 425. The insert 470 may have a thickness that is less than or equal to the depth of the cavity 425. In certain embodiments, the insert 470 may have a thickness of about 0.032 inches thick, although other thicknesses are also possible. However, in most embodiments, the thickness of the insert 470 is less than the thickness of the body 410, so that a cavity 425 may be created in the body 410. The insert 470 may also have a diameter of about 1.375 inches. In certain embodiments, the inserts 470 are pressed into the cavities 425 using a friction fit. In other embodiments, an adhesive may be disposed between the insert 470 and the body 410 to further secure the insert 470 to the body 410. The inserts 470 may have a small notch or irregularity along its circumference to allow a screwdriver blade or other similar tool to pry the insert 470 off the cavity 425.

The cavities 425 in the body 410 may be created by adding an insert in the mold for the body 410. This mold insert is disposed in the location where the cavity 425 is to be created. In this way, the body 410, as molded, has the cavities 425. However, in other embodiments, the cavity 425 may be created after the body 410 is created, such as by removing material from the upper surface 420 of the body 410.

The inserts 470 are photoluminescent and may be fabricated by introducing a photoluminescent pigment into the plastic used to create the insert 470 in the molding process. For example, in some embodiments, the photoluminescent pigment may be zinc sulfide, strontium silicate, strontium aluminate or other alkaline earth aluminates. Of course, other photoluminescent materials may also be used and the disclosure is not limited to these illustrative examples.

Thus, in this embodiment, the insert 470 is a plastic component which is photoluminescent. In certain embodiments, the inserts 470 are the only part of the CIP TWS unit 400 that is photoluminescent. In other words, the body 410 is not made from a photoluminescent material.

In other embodiments, the inserts 470 may be made from a metal substrate. For example, thin discs may be punched or otherwise created from aluminum or another metal. In one particular embodiment, the discs may have a diameter of about 1.375 inches. At least the front surface of these metal discs may then be covered with a photoluminescent material, such as strontium aluminate or another material. In other embodiments, the photoluminescent material is disposed on both surfaces of the metal disc. This photoluminescent material may be painted onto the metal disc or otherwise applied. In certain embodiments, the photoluminescent material may then be coated with a ceramic material. This ceramic coating serves to protect the underlying photoluminescent material from wear and damage. In one particular embodiment, the total thickness of the insert 470 may be about 0.81 mm thick, where the metal disc is about 0.56 mm thick and where the combined thickness of the photoluminescent material and ceramic coating is about 0.25 mm. In one particular embodiment, the cavity 425 may be about 1.4 mm deep. The thickness of the insert 470 allows an adhesive having a thickness of 0.6 mm to be applied between the body 410 and the insert 470 without having the insert 470 protrude past the upper surface 420. In certain embodiments, the photoluminescent material is a 300 grade material. In other embodiments, the photoluminescent material may be more photoluminescent, such as a 500 grade material.

In other embodiments, the inserts 470 may be made from an acrylic substrate. Acrylic discs may be formed. In one particular embodiment, the discs may have a diameter of about 1.375 inches. Then, at least the front surface of these acrylic discs may then be covered with a photoluminescent material, such as strontium aluminate or another material. In other embodiments, the photoluminescent material is disposed on both surfaces of the acrylic disc. This photoluminescent material may be painted onto the acrylic disc or otherwise applied. In certain embodiments, the acrylic disc may then be coated with a ceramic material to protect the photoluminescent material. One benefit of acrylic discs is that they are difficult to remove without breaking, making them less susceptible to theft or vandalism.

Thus, the inserts for the SA TWS unit 200 and the CIP TWS unit 400 serve only as photoluminescent features. In other words, this is the purpose of these inserts. In contrast, the caps 170 for the replaceable TWS unit 100 also serve to cover and protect the fasteners 150.

Furthermore, the inserts described above can also be used for the replaceable TWS units described above. For example, cavities may be formed in a replaceable TWS unit. Like SA and CIP TWS units, the cavities in the body may be created by adding an insert in the mold for the body. This mold insert is disposed in the location where the cavity is to be created. In this way, the body, as molded, has the cavities. However, in other embodiments, the cavity may be created after the body is created, such as by removing material from the upper surface of the body. The inserts used to fill these cavities may be the same as the caps 170 described above. In other embodiments, these inserts may be made from metal or acrylic discs, as described above.

In certain embodiments, a replaceable TWS unit may have both photoluminescent caps 170 and photoluminescent inserts. These caps and inserts may have the same diameter. In certain embodiments, the diameter may be 1.375 inches. In certain embodiments, the photoluminescent caps 170 and photoluminescent inserts may be arranged in one or more lines. In other embodiments, a replaceable TWS unit have utilize traditional non-photoluminescent caps with the photoluminescent inserts. In other embodiments, the replaceable TWS unit may have photoluminescent caps 170 and not include inserts. Thus, replaceable TWS units may be made with only photoluminescent caps 170, only photoluminescent inserts, or a combination of both features.

In certain embodiments, the cavities 225, 425 of the SA TWS unit 200 and the CIP TWS unit 400, respectively, are sized so as to accommodate the caps 170 that are designed to fit into recess 142 of the replaceable TWS unit 100. In this way, one part may be used for a plurality of different types of TWS units. In other embodiments, unique caps and inserts may be designed for each unit. For example, the inserts used for SA and CIP TWS units may be thinner than the caps 170 used for replaceable TWS units.

In certain embodiments, when a plurality of TWS units are placed next to one another, side by side, a single dotted line of photoluminescent caps or inserts may be created. This effect may be achieved using replaceable TWS units, SA TWS units, or CIP TWS units. When used on a platform, this single dotted line may be disposed on the edge of the TWS unit that is furthest from the edge of the platform so as to give users a visual warning well in advance of the drop-off. This edge may be referred to as the approach side of the TWS unit. Thus, a plurality of TWS units may create a photoluminescent dotted line along the approach side. In certain embodiments, the configuration of the photoluminescent caps or inserts is such that the spacing between adjacent caps or inserts on a TWS unit is the same or within 1 inch of the spacing between adjacent caps or inserts on adjacent TWS units. In one particular embodiment, the spacing between adjacent caps or inserts on one TWS unit may be about 12.25 inches, while the spacing between adjacent caps or inserts on adjacent TWS units may be about 12.15 inches.

While FIGS. 2A-2D, 3, and 4A-4B show the inserts as being circular, other shapes are also possible. In fact, the shape of the insert is not limited by this disclosure and in certain embodiments, may be rectangular, square, triangular, oval, elliptical or any other desired shape. For example, in certain embodiments, the insert may be in the shape of a strip, which is much longer than it is wide.

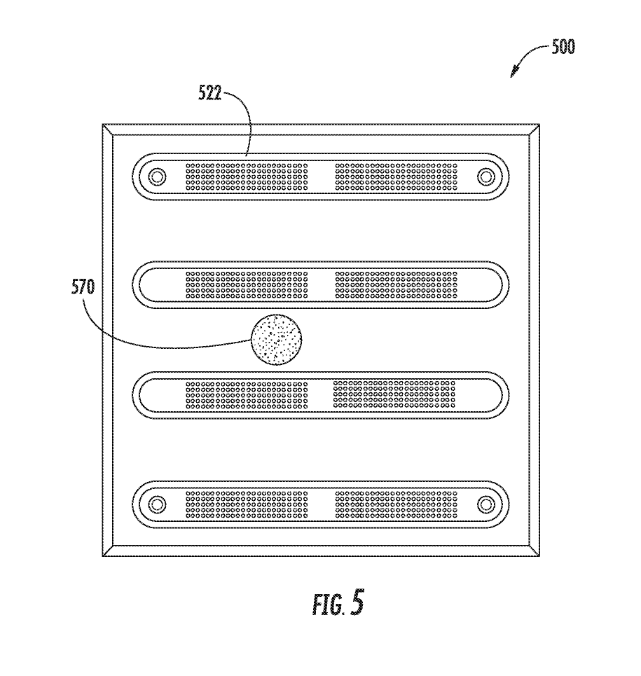

While the figures show the photoluminescent caps or inserts used with TWS units that have domes, other embodiments are also possible. For example, FIG. 5 shows a TWS unit 500 that has one or more oblong bars 522 on its top surface, rather than domes. In this embodiment, the insert 570 may be disposed between two oblong bars 522.

Furthermore, while the embodiments shown above depict TWS units that are made from homogenous fiberglass-reinforced composite material, other embodiments are also possible. For example, the body of the TWS unit may be made of a different material, including metals, such as iron.

In addition to photoluminescence, in certain embodiments, the caps 170 or inserts 270, 470 may also be reflective. For example, both photoluminescent material and reflective material may be used to create the caps or inserts. The inclusion of reflective material may be advantageous in environments where there is typically at least some low level light, such as curb ramps.

The use of photoluminescent caps or inserts as described herein have many benefits and advantages. First, by creating a cavity into which the cap or inserts is placed, the height of the TWS unit is not affected by the inclusion of the photoluminescent features. Tus, the risk of tripping is not increased by the incorporation of these features.

Second, the attachment mechanism improves the durability and reliability of the photoluminescent features. Unlike conventional approaches, which use adhesive to attach the strips to the surface of the unit, the present system creates a cavity in the unit, into which the photoluminescent feature can be inserted, such as by a friction fit. Thus, the cap or insert is not subject to the lateral forces that other photoluminescent features experience.

Third, the use of cavities in the TWS unit allows the photoluminescent features to be disposed on the selected area of the unit. As shown in FIGS. 1A, 2A, 3, 4A and 5, the cavities may be disposed in any configuration that is suitable for the photoluminescent features. For example, as shown in FIGS. 2A and 4A, the photoluminescent features can be arranged to form a straight line.

Fourth, the use of round caps and inserts may have additional benefits. For example, the round features present a visual cue that is more directional in nature than a photoluminescent strip. These round features are far more distinct and less confusing to persons with impaired vision. The use of these round features may be used to form a photoluminescent dotted line, when multiple TWS units are placed adjacent to one another. This photoluminescent dotted line may serve as a guidance path as well as a source of illumination.

Fifth, in some embodiments, by creating cavities, the photoluminescent caps and inserts may be made thicker than would otherwise be possible. Thicker photoluminescent material exhibits superior and longer lasting luminance. Luminance is a function of the intensity of the light source and charge time. Only so much light energy can be stored and emitted by the cap. Thicker caps and inserts are able to store more light energy. Furthermore, the thicker caps and inserts also provide superior performance, luminance, and structural integrity.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A replaceable tactile warning tile, comprising:
a body having an upper surface and a lower surface;
one or more holes passing through the body; and
a cap disposed on the upper surface and covering one of the holes, wherein the cap is photoluminescent.

2. The replaceable tactile warning tile of claim 1, wherein the cap is held in place using a friction fit.

3. The replaceable tactile warning tile of claim 1, wherein the cap comprises strontium aluminate.

4. The replaceable tactile warning tile of claim 1, wherein a top surface of the cap comprises a plurality of dimples and the upper surface comprises a plurality of dimples.

5. The replaceable tactile warning tile of claim 1, further comprising a fastener passing through one of the holes and an anchor disposed on the lower surface, wherein the fastener secures the anchor against the lower surface, and the cap covers the fastener.

6. The replaceable tactile warning tile of claim 1, wherein the cap is plastic.

7. The replaceable tactile warning tile of claim 1, further comprising a cavity disposed on the upper surface, and an insert disposed in the cavity, where the insert is photoluminescent.

8. A tactile warning tile, comprising:
a body having an upper surface and a lower surface, and a cavity disposed on the upper surface; and
an insert disposed in the cavity, where the insert is photoluminescent.

9. The tactile warning tile of claim 8, wherein the depth of the cavity is greater than or equal to the thickness of the insert.

10. The tactile warning tile of claim 9, wherein the depth of the cavity is less than the thickness of the body.

11. The tactile warning tile of claim 8, wherein the cavity and insert are circular.

12. The tactile warning tile of claim 8, wherein the insert is held in place using a friction fit.

13. The tactile warning tile of claim 8, wherein the insert is held in place using an adhesive.

14. The tactile warning tile of claim 8, wherein the insert comprises strontium aluminate.

15. The tactile warning tile of claim 8, wherein a top surface of the insert comprises a plurality of dimples and the upper surface comprises a plurality of dimples.

16. The tactile warning tile of claim 8, wherein a plurality of rows of domes are disposed on the upper surface and the cavity is disposed between adjacent rows of domes in two directions.

17. The tactile warning tile of claim 8, wherein at least one oblong bar is disposed on the upper surface.

18. The tactile warning tile of claim 8, wherein the insert is plastic.

19. The tactile warning tile of claim 8, wherein the insert comprises metal.

20. The tactile warning tile of claim 19, wherein the insert comprises a photoluminescent material disposed on an aluminum disc.

21. The tactile warning tile of claim 20, wherein the photoluminescent material is coated with a ceramic material.

22. The tactile warning tile of claim 8, wherein the insert comprises a photoluminescent material disposed on an acrylic disc.

23. The tactile warning tile of claim 8, wherein the tile comprises a surface applied tactile warning tile.

24. The tactile warning tile of claim 8, wherein the tile comprises a cast-in-place tactile warning tile.

25. The tactile warning tile of claim 8, wherein the tile comprises a replaceable tactile warning tile.

26. The tactile warning tile of claim 8, wherein the tile comprises a metal.

27. The tactile warning tile of claim 8, wherein the insert also comprises a reflective material.

28. The tactile warning tile of claim 8, wherein the tile comprises a plurality of inserts, and the inserts are spaced apart and arranged in a line.

29. A method of adding photoluminescence to an existing tactile warning system tile, the existing tile being a replaceable tactile warning system tile comprising one or more anchors embedded in an underlying substrate and secured to the tile using a fastener, where a cap is disposed on an upper surface of the tile and covers the fastener, the method comprising:
removing the existing cap from the upper surface of the tile; and
installing a photoluminescent cap where the existing cap was previously disposed.

30. The method of claim 29, wherein the tile is not removed from the substrate.

31. The method of claim 29, wherein the photoluminescent cap is installed without the use of adhesive.

32. The method of claim 29, wherein the photoluminescent cap is plastic.
